(19) United States
(12) Patent Application Publication
(10) Pub. No.: US 2026/0277570 A1
(43) Pub. Date: Sep. 17, 2026

(54) NON-TRANSITORY COMPUTER-READABLE STORAGE MEDIUM STORING A PROGRAM, DATA PROCESSING APPARATUS, AND DATA PROCESSING METHOD

(71) Applicant: Kabushiki Kaisha Toshiba, Kawasaki-shi, Kanagawa (JP)

(72) Inventor: Shimon KAYASHIMA, Yokohama Kanagawa (JP)

(21) Appl. No.: 19/548,818

(22) Filed: Feb. 24, 2026

(30) Foreign Application Priority Data
Mar. 12, 2025 (JP) 2025-039303

(51) Int. Cl. G06F 8/41

(52) U.S. Cl. CPC G06F 8/41

(57) ABSTRACT

According to one embodiment, a non-transitory computer-readable storage medium storing a program that causes a processing circuitry to execute operations includes comparing a first commit and a second commit for a first variation branch branching from a development branch at a first timing, and extracting the second commit as a commit for a first variation when there is a difference between the first commit and the second commit, wherein the first commit and the second commit are programs described in a source code and are registered in a configuration management tool, and the first commit and the second commit are registered in a development branch of the configuration management tool after the first timing.

### CROSS-REFERENCE TO RELATED APPLICATIONS

This application is based upon and claims the benefit of priority from Japanese Patent Application No. 2025- 039303, filed Mar. 12, 2025, the entire contents of which are incorporated herein by reference.

### FIELD

Embodiments described herein relate generally to a non-transitory computer-readable storage medium storing a program, a data processing apparatus, and a data processing method.

### BACKGROUND

In a software development architecture, there is a case where a plurality of variations of models, specifications, and the like are included in one source tree and managed. The option at the time of compilation is changed, and as a result, the compilation switch expressed by a macro or the like is turned on / off, thereby expressing the variation. This allows source code to be written in which a change affects only a specific variation.

In general, the source code is managed by registering the source code in a configuration management tool. The configuration management tool has a registration space (branch) for each release and development work. The branches include a main branch in which all variations such as all models and all specifications are registered, and a release branch customized to a certain model and specification is branched from the main branch and development is continued in parallel. At the time of release, it is desired to take in new functions and trouble modifications registered in the main branch and other release branches, but it is necessary to determine which registration should be taken in in order to take in without omission.

### BRIEF DESCRIPTION OF THE DRAWINGS

FIG. 1 is a schematic diagram showing an example of a flow of branches in a configuration management tool.

FIG. 2 is a block diagram showing an example of an outline of a data processing apparatus according to the embodiment.

FIG. 3 is a flowchart showing an example of a flow of a data processing method according to the embodiment.

FIG. 4 is a flowchart showing an example of a flow of a data processing method according to the embodiment.

FIG. 5 is a schematic diagram showing an example of a flow of branches in the configuration management tool.

FIG. 6 is a schematic diagram showing an example of a flow of branches in the configuration management tool.

FIG. 7 is a schematic diagram showing an example of a flow of branches in the configuration management tool.

FIG. 8 is a flowchart showing an example of a flow of a data processing method according to the embodiment.

FIG. 9 is a schematic diagram showing a modification of the flow of branches in the configuration management tool.

FIG. 10 is a block diagram showing a modification of the outline of the data processing apparatus according to the embodiment.

FIG. 11 is a flowchart showing a modification of the flow of the data processing method according to the embodiment.

### DETAILED DESCRIPTION

In general, according to an aspect of the invention, there is provided a non-transitory computer-readable storage medium storing a program that causes a processing circuitry to execute operations includes comparing a first commit and a second commit for a first variation branch branching from a development branch at a first timing, and extracting the second commit as a commit for a first variation when there is a difference between the first commit and the second commit, wherein the first commit and the second commit are programs described in a source code and are registered in a configuration management tool, and the first commit and the second commit are registered in a development branch of the configuration management tool after the first timing.

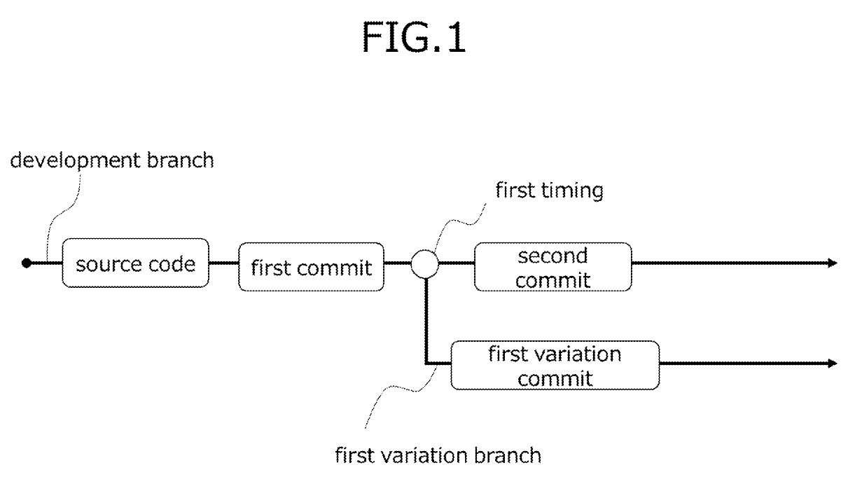

FIG. 1 is a schematic diagram showing an example of a flow of branches in a configuration management tool. The configuration management tool includes a development branch that is a main branch and a first variation branch that is a release branch. The development branch includes a first commit and a second commit. The first commit is a commit in which a change point of the source code is registered in the development branch when the source code is modified using a first build deliverable that is a deliverable of the first build. The second commit is a commit in which a change point of the source code is registered in the development branch when the source code is modified using a second build deliverable that is a deliverable of the second build. Here, it is considered that the first variation branch branches from the development branch at the first timing. Before the first timing, the first commit registered in the development branch is included in the first variation commit. On the other hand, after the first timing, the second commit registered in the development branch is not reflected in the first variation branch. Therefore, it is necessary to reflect the modification performed in the development branch after the first timing on the first variation branch. However, if all the modifications are incorporated, modifications unrelated to the first variation are also incorporated, and thus the amount of data increases. Therefore, the data processing program according to the embodiment can select only the modification that has an influence on releasing the first variation and reflect the modification on the first variation.

In the data processing program according to the present embodiment, the commit of the target source code is taken from the following three viewpoints.

(1) In the variation of the model / specification, when the first commit and the second commit are registered in succession, a difference occurs between the build deliverables used when the commits are registered, and a difference occurs when the software is executed. Therefore, the second commit is taken in. Conversely, if there is no difference in the build deliverables, there is no influence on the variation. Therefore, it is not necessary to incorporate the second commit. (2) Even if there is no difference in (1) at the time of registration, a commit that may affect subsequent registration is incorporated. (3) In the incorporation from another release branch, since there may be an erroneous determination only with the difference in the build deliverable, the comment of the task management tool is also verified. In addition, the determination in the similar case executed in the past is also referred to.

Hereinafter, embodiments will be described with reference to the drawings. In the following description, the same reference numerals are given to constituent elements having the same or similar functions throughout the drawings, and redundant description will be omitted. The drawings are schematic diagrams for explaining the embodiments and facilitating the understanding thereof, and the shapes, dimensions, ratios, and the like thereof may be different from those of actual devices, but these can be appropriately changed in design in consideration of the following explanation and known techniques.

### First Embodiment

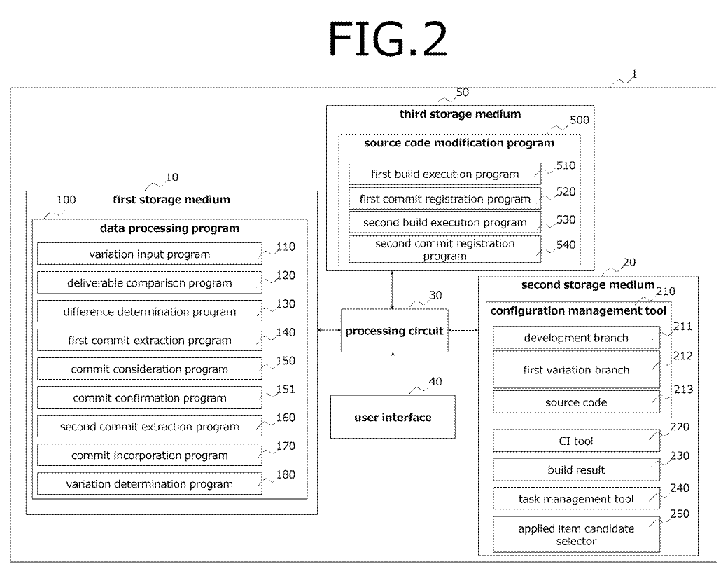

FIG. 2 is a block diagram illustrating an example of an outline of a data processing apparatus according to the embodiment. The data processing apparatus 1 includes a first storage medium 10, a second storage medium 20, a processing circuit 30, and a third storage medium 50. The data processing apparatus 1 may further include a user interface 40.

The first storage medium 10 is a storage medium that stores, for example, a data processing program 100. The first storage medium 10 includes a data processing program 100. The data processing program 100 includes a variation input program 110 for inputting a variation to be released to the applied item candidate selector 250, a deliverable comparison program 120 for comparing a first build deliverable and a second build deliverable, a difference determination program 130 for determining whether there is a difference between the first build deliverable and the second build deliverable, a first commit extraction program 140 for extracting a commit to be incorporated as a commit to be reflected in the first variation, a commit consideration program 150 for considering extraction of commits other than the extracted commit, a commit confirmation program 151 for confirming a relationship between the extracted commit and a commit already registered in the development branch, a second commit extraction program 160 for extracting a commit registered before the extracted commit as a commit to be incorporated into the first variation, and a commit incorporation program 170 for incorporating the extracted commit into the first variation branch. The data processing program 100 may further include a variation determination program 180 for determining the influence of a variation.

The second storage medium 20 is a storage medium that stores, for example, a tool used to execute the data processing program 100. The second storage medium 20 includes a configuration management tool 210, a CI tool 220, a build result 230, a task management tool 240, and an applied item candidate selector 250.

The third storage medium 50 is a storage medium that stores, for example, the source code modification program 500. The third storage medium 50 includes a source code modification program 500. The source code modification program 500 includes a first build execution program 510 that executes a first build on the source code, a first commit registration program 520 that registers a first commit in the development branch, a second build execution program 530 that executes a second build on the source code on which the first commit is reflected, and a second commit registration program 540 that registers a second commit in the development branch.

The first storage medium 10, the second storage medium 20, and the third storage medium 50 are storage devices referred to as main storage devices or auxiliary storage devices. The first storage medium 10, the second storage medium 20, and the third storage medium 50 are, for example, a magnetic disk, an optical disk (CD-ROM, CD-R, DVD, etc.), a magneto-optical disk (MO, etc.), a semiconductor memory, or the like. The data processing apparatus 1 may include only one memory or the like serving as the first storage medium 10, the second storage medium 20, or the third storage medium 50, or may include a plurality of memories or the like. The first storage medium 10, the second storage medium 20, and the third storage medium 50 store programs executed by the processing circuit 30, data of results of executing the programs, and the like.

The configuration management tool 210 manages changes and releases of the source code 213. The configuration management tool 210 includes a development branch 211, a first variation branch 212, and a source code 213. The configuration management tool 210 is, for example, Git or Subversion.

Variations according to all models and specifications are registered in the development branch 211. The model indicates a change depending on the age or generation, and indicates a change in time series. Specification refers to something that is released in the same age but is localized.

The first variation branch 212 branches from the development branch 211. The first variation branch 212 is a branch for releasing a model equipped with the first variation. The development branch 211 and the first variation branch 212 are not synchronized.

The source code 213 is a code written to define the function and operation of the program, and is written in a programming language. A plurality of users can edit the source code 213, and this editing is mainly performed in the development branch 211.

The CI tool 220 is also referred to as a continuous integration tool. The CI tool 220 performs a build in a flow described later. The CI tool 220 may be, for example, a Jenkins.

The build result 230 is a deliverable when a first build described later is executed. The build result 230 is, for example, an executable file, a library, a document, or the like. Build result 230 may be any value that allows identity determination, such as a hash value.

The task management tool 240 records supplementary information of the commit such as the application range of the variation. The information recorded in the task management tool 240 is used for a difference determination of a commit described later.

Information related to a variation for which a difference determination of a build deliverable is desired to be performed is input to the applied item candidate selector 250. Specifically, information including the variation and the compilation deliverable thereof is input. Each variation has its own compile time parameters, and the influence of the parameters appears in the compilation deliverable. Therefore, the compilation deliverable can be used to determine whether there is a difference in commit for each variation. The compilation deliverable is used to determine whether or not there is a difference in the deliverable of the build described later.

The processing circuit 30 is configured by a processor, an integrated circuit, or the like, and the processor or the like configuring the processing circuit 30 includes any of a central processing unit (CPU), an application specific integrated circuit (ASIC), a microcontroller unit (MCU), a field programmable gate array (FPGA), a digital signal processor (DSP), and the like. The processing circuit 30 may be configured by one processor or the like, or may be configured by a plurality of processors or the like. The processing circuit 30 performs processing described later by executing the data processing program 100.

In FIG. 2, the case where the data processing program 100 is stored in the first storage medium 10 has been described. The data processing program 100 can be stored in the second storage medium 20 or the third storage medium 50, or can be stored in another storage medium (not shown). The data processing program 100 may execute an instruction issued from the processing circuit 30. Therefore, the programs may be stored in different storage media. The data processing program 100 may be executed in a cloud.

The user interface 40 can output information related to information processing of the data processing apparatus 1 and input related to information processing of a variation by a user or the like of the data processing apparatus 1. Therefore, the user interface 40 is provided with an output device that outputs information related to the information processing of the variation. The output device outputs information to the outside by screen display, sound transmission, vibration, or the like. The output device can receive an instruction from the processing circuitry 30 and output a difference of a build deliverable, a result extracted as a commit for a predetermined variation, and the like to a user. The user interface 40 is provided with an input device for the user to input an operation. The input device is configured by, for example, one or more of a button, a mouse, a touch panel, a keyboard, a voice input device, and the like. The user interface 40 may be provided separately from the data processing apparatus 1.

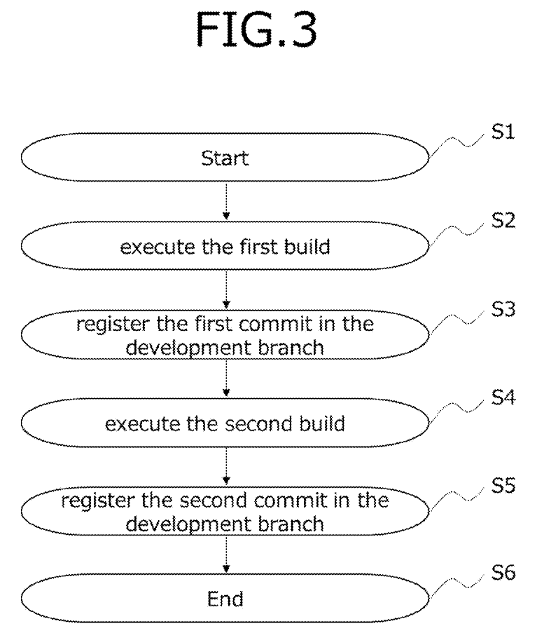

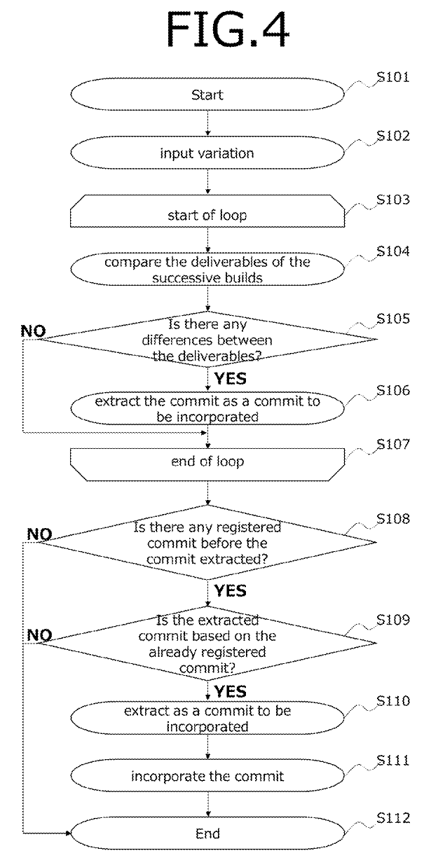

FIGS. 3 and 4 are flowcharts illustrating an example of a flow of a data processing method according to the embodiment. Here, a state after the source code 213 is registered in the configuration management tool 210 will be described. The flowchart of FIG. 3 is a flow when a commit is registered in a development branch. The data processing program according to the embodiment compares the build deliverables with each other to determine whether there is a difference. Therefore, the flow of FIG. 3 is performed before the flow of FIG. 4. In addition, in the development branch including before and after the branching of the first variation branch, the commit is registered in the development branch at least twice. The flowcharts of FIGS. 3 and 4 are examples, and the order of the processes is not limited as long as a necessary processing result can be acquired. Further, each processing result may be sequentially stored in the first storage medium 10 or the second storage medium 20, and each step may acquire the processing result by referring to the first storage medium 10 or the second storage medium 20. The same applies to the following flowcharts.

In step S2 of FIG. 3, the processing circuit 30 performs the first build on the source code in the initial state by reading and executing the first build execution program 510. The first build is performed using the CI tool 220. As a result, a deliverable of the first build is generated. The deliverable of the first build can be stored in the second storage medium 20 as a build result 230.

In step S3, the processing circuit 30 registers the first commit in the development branch 211 by reading and executing the first commit registering program 520. The first commit includes a change from the source code in the initial state. Therefore, the source code in which the first commit is reflected may be different from the source code in the initial state. When the first commit is registered in the development branch 211, the source code can be modified using the deliverable of the first build acquired in step S2.

In step S4, the processing circuit 30 executes the second build on the source code on which the first commit is reflected by reading and executing the second build execution program 530. The second build is performed using the CI tool 220. As a result, a deliverable of the second build is generated. The deliverable of the second build can be stored in the second storage medium 20 as a build result 230.

In step S5, the processing circuit 30 registers the second commit in the development branch 211 by reading and executing the second commit registering program 540. The second commit includes a change from the source code in which the first commit is reflected. Therefore, the source code in which the second commit is reflected may be different from the source code in which the first commit is reflected. When the second commit is registered in the development branch 211, the source code can be modified using the deliverable of the second build in step S4.

In step S102 of FIG. 4, the processing circuit 30 inputs information on the variation to be released to the applied item candidate selector 250 by reading and executing the variation inputting program 110. Here, the first variation and the compilation deliverable of the first variation are input to the applied item candidate selector 250.

In steps S103 and S107, the processing circuitry 30 performs a loop in a range from S103 to S107. This loop is repeated until the comparison between the deliverables of the successive builds used when the commit is registered is completed.

In step S104, the processing circuitry 30 compares the deliverable of the first build executed in step S2 in FIG. 3 with the deliverable of the second build executed in step S4 by reading and executing the deliverable comparison program 120. The comparison of the build deliverables is performed on all the build deliverables for which the builds have been executed, with the deliverables of the successive builds such as the deliverable of the first build and the deliverable of the second build being the targets.

In step S105, the processing circuitry 30 determines whether there is a difference between the deliverable of the first build and the deliverable of the second build by reading and executing the difference determination program 130. The difference here refers to additional information included in the deliverable of the second build when the deliverable of the first build and the deliverable of the second build are compared. Since the determination of the presence or absence of differences may differ depending on the variation, the determination is performed from the viewpoint of the variation input to the applied item candidate selector 250 in step S102. If it is determined that there is a difference (YES), the process proceeds to step S106. If it is determined that there is no difference (NO), the process proceeds to step S107.

In step S106, the processing circuit 30 extracts the commit registered using the build deliverable determined to have a difference in step S105 as a commit to be incorporated into the first variation by reading and executing the first commit extraction program 140.

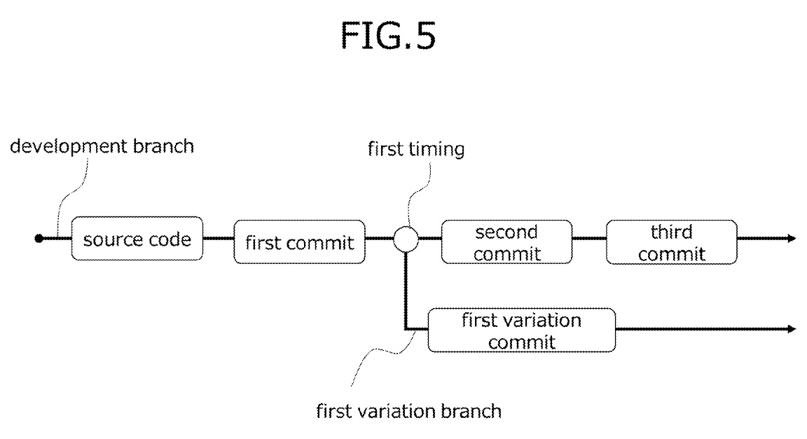

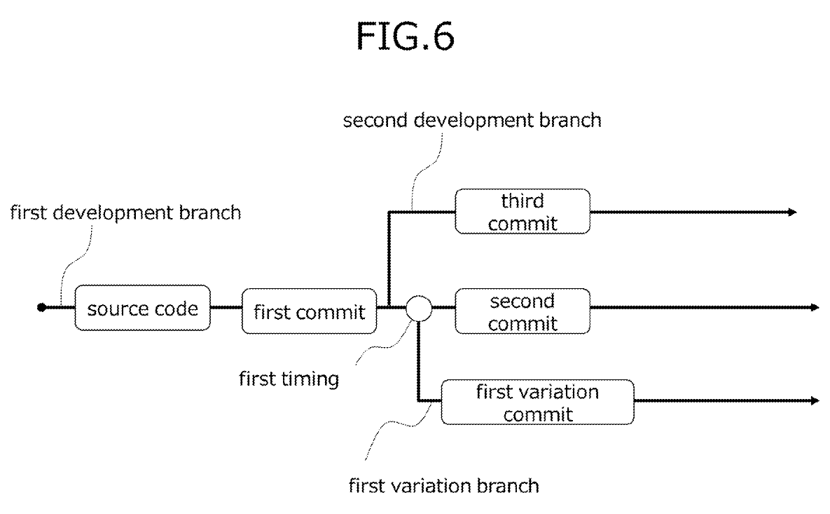

In step S108, the processing circuit 30 considers extraction of commits other than the commits extracted in step S106 by reading and executing the commit consideration program 150. To be specific, it is determined whether or not there is a commit registered in the development branch before the commit extracted in step S106. If it is determined that there is a commit (YES), the process proceeds to step S109. If it is determined that there is no commit (NO), the process proceeds to step S112. The consideration of the S108 will be described with reference to FIG. 5. FIG. 5 is a schematic diagram illustrating an example of a flow of a branch in the configuration management tool. In FIG. 5, in addition to the flow of FIG. 1, a third commit is registered in the development branch. Here, in FIG. 5, a case of incorporating a commit for the first variation is considered. In the case where in step S105 determines that there is no difference between the first commit and the second commit and there is a difference between the second commit and the third commit, only the third commit is extracted in step S106 as a target to be incorporated into the first variation. However, when the third commit is a result of modifying the source code based on the second commit, the second commit also needs to be incorporated into the first variation branch 212 in releasing the first variation. Therefore, in step S108, it is provided so that it can be determined that the second commit in FIG. 5 is also extracted. In FIG. 6, in addition to the flow of FIG. 5, a second development branch is branched from the first development branch. The second development branch branches at a timing after the first commit is registered and before the first timing. In such a case, the third commit is not a result of modification based on the second commit, and therefore, the second commit does not need to be incorporated into the first variation branch 212.

In step S109, the processing circuit 30 confirms the relationship between the commit extracted in step S108 and the commit registered in the development branch before the extracted commit by reading and executing the commit confirmation program 151. When the extracted commit is a commit in which the source code is modified based on the already registered commit (YES), the process proceeds to step S110. When the extracted commit is modified without considering the already registered commit (NO), the process proceeds to step S112. If there are a plurality of registered commits in the development branch before the extracted commit, the relationship between the extracted commit and the registered commit can be confirmed.

In step S110, the processing circuit 30 extracts, as a commit to be incorporated into the first variation, a commit that is registered in the development branch before the commit extracted in step S106 and recognized as having a relationship in step S109 by reading and executing the second commit extraction program 160.

In step S111, the processing circuit 30 incorporates the commit extracted in S106 and S110 into the first variation branch 212 by reading and executing the commit incorporation program 170.

The data processing program according to the embodiment incorporates only the affected commit into the first variation branch 212. This enables the release branch to incorporates appropriate data.

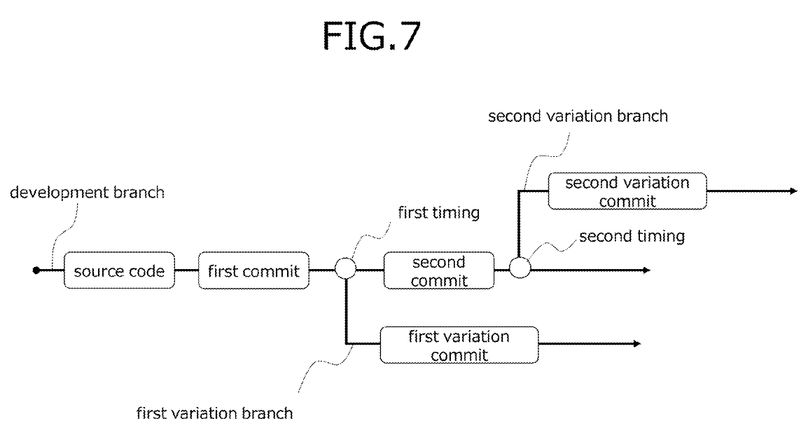

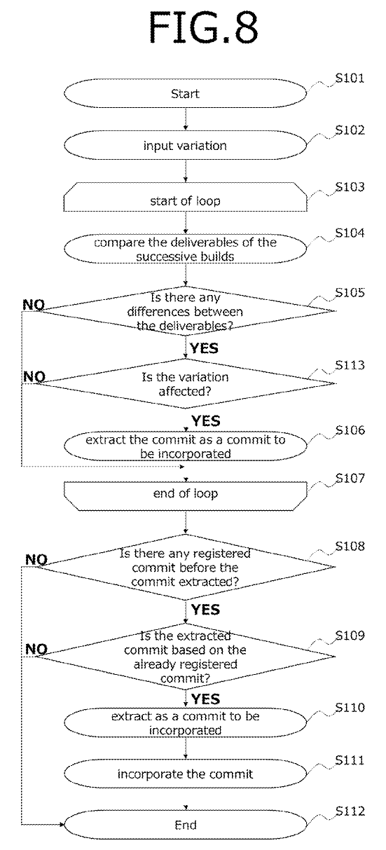

The data processing program according to the embodiment can incorporate appropriate data even when there are two release branches as illustrated in FIG. 7. A case of incorporating a commit for the first variation will be described with reference to FIGS. 7 and 8. In FIG. 7, in addition to the flow of FIG. 1, a second variation branch is branched from the development branch at a second timing. The second variation branch is a release branch. The second variation branch includes a second variation commit. The modification of the source code performed before the second timing is included in the second variation commit. FIG. 8 is the same as FIG. 4 except that step S113 is added between step S105 and step S106. Therefore, only step S113 will be described here.

The second commit and the second variation commit are compared in step S104, and when it is determined that there is a difference in the commit in the S105, the second variation commit is extracted as a commit to be incorporated into the first variation in step S106. The second variation commit has a difference for the first variation, but has no influence because the second variation commit is not a modification targeting the first variation. In this case, in step S113 in FIG. 8, the processing circuitry 30 determines whether there is an influence on the variation input in step S102 by reading and executing the variation determination program 180, with reference to the information described in the task management tool 240. Since the application range of each commit is described in the task management tool 240, only the commit for the first variation can be extracted by referring to this information, and appropriate data can be incorporated in. If the variation is affected (YES), the process proceeds to step S106. If there is no influence on the variation (NO), the process proceeds to step S107. In the case of the second variation commit, it is determined that the second variation commit does not affect the first variation, and the second variation commit is not extracted as a commit to be incorporated into the first variation.

### Second Embodiment

When compiling the same source code with different build settings, a compile switch may be applied. This enables a specific function or setting to be enabled or disabled. In the second embodiment, a case where the compile switch is switched will be described. The switching of the compile switch may be from enabled to disabled or vice versa. Here, a case where the state is switched from the disabled state to the enabled state will be described.

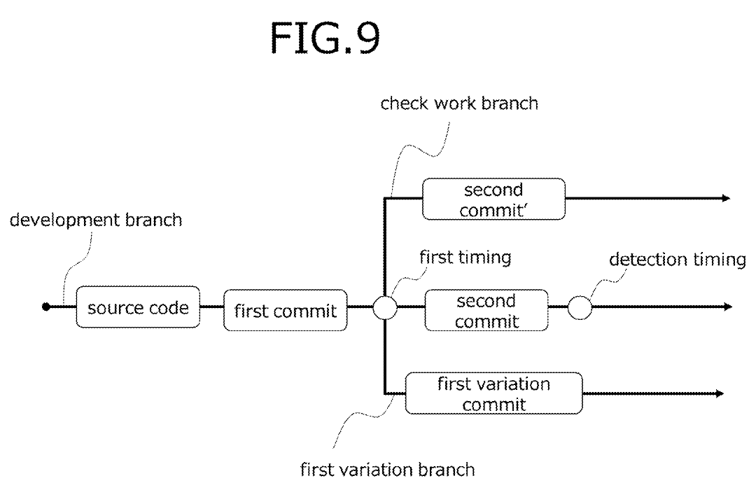

FIG. 9 is a schematic diagram illustrating a modification of the flow of branches in the configuration management tool. In FIG. 9, in addition to the flow of FIG. 1, a check work branch branches from the development branch at the first timing. The check work branch is a branch for checking whether or not a commit is to be registered in the first variation. The check operation branch includes a second commit and a second commit′. The second commit′ is a commit acquired by copying the second commit registered in the development branch, but the state of the applied compile switch is different. In the development branch, when the compile switch is switched from the disabled state to the enabled state at the detection timing, the first variation may not be a target of the build executed until the compile switch is switched. Therefore, it is not known whether the commit registered in the development branch 211 is a commit that affects the first variation. Therefore, in order to determine whether or not the commit is for the first variation, the check work branch 214 is branched from the development branch 211 at the first timing, and the commit registered in the development branch 211 is incorporated. At this time, the build is executed so as to apply the validated compile switch to the first variation, and the commit to be incorporated into the first variation is extracted. Accordingly, even when the switching of the compile switch occurs, the data processing program according to the embodiment can perform the incorporation of appropriate data.

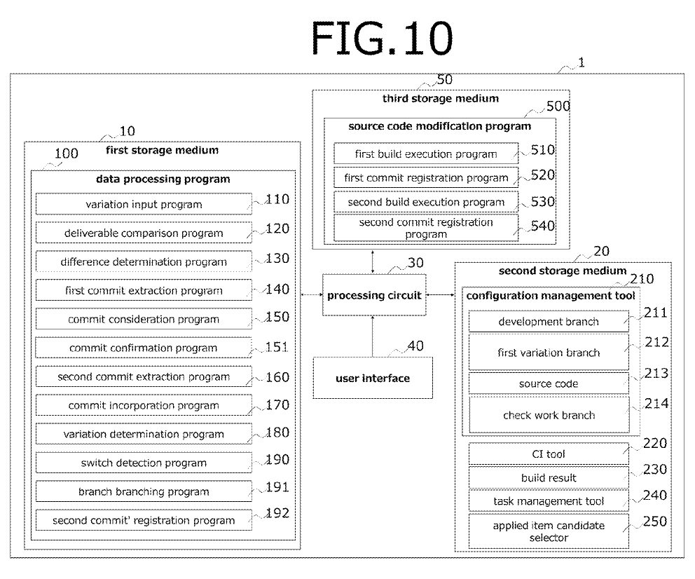

FIG. 10 is a block diagram illustrating a modification of the schematic configuration of the data processing apparatus according to the embodiment. The data processing program 100 of FIG. 10 further includes a switch detection program 190 for detecting switching of the compile switch, a branch branching program 191 for branching the check work branch, and a second commit' registration program 192 for registering a commit in the check work branch 214, in addition to the data processing program 100 of FIG. 2. The configuration management tool 210 of FIG. 10 further includes a check work branch 214 in addition to the configuration management tool 210 of FIG. 2. The check work branch 214 branches from the development branch 211.

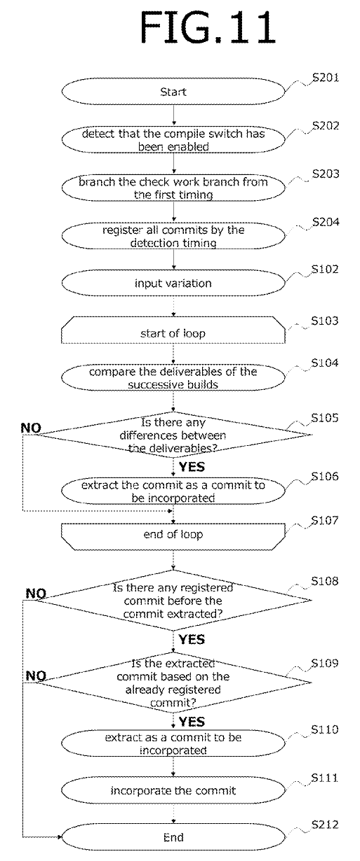

FIG. 11 is a flowchart illustrating a modification example of the flow of the data processing method according to the embodiment. The flowchart of FIG. 11 is similar to the flowchart of FIG. 4 in which step S202 to S204 are added between step S101 and S102, and thus only step S202 to S204 will be described here.

In step S202, the processing circuit 30 detects that the compile switch in the first variation has been enabled in the development branch 211 by reading and executing the switch detection program 190.

In the S203, the processing circuit 30 branches the check work branch 214 from the first timing, which is the timing at which the first variation branches by reading and executing the branch branching program 191. The check work branch 214 is not affected by the switching of the compile switch. Therefore, when extracting the commit based on the presence or absence of the differential from step S103 to S107, the commit registered in the check work branch 214 is used instead of the development branch 211.

In the S204, the processing circuit 30 registers all commits registered in the development branch 211 by the detection timing in the check work branch 214 by reading and executing the second commit' registration program 192. At this time, the compile switch is registered in the check work branch 214 in an enabled state. In FIG. 9, the second commit is a commit registered in the check work branch 214.

### Other Embodiments

In the first embodiment, the case where the commit is performed twice has been described, but the number of times of commit is not limited, and the data processing program according to the embodiment can determine whether to appropriately incorporate data regardless of the number of times of commit.

In the second embodiment, the case where the compile switch of the first variation is enabled from disabled has been described. The present invention is also applicable to variations other than the first variation. The check work branch may branch at the same timing as the timing at which the target variation branches from the development branch.

In the description of the first embodiment, in step S110, the processing circuit 30 extracts, as a commit to be incorporated into the first variation, a commit that is registered in the development branch before the commit extracted in S106 and recognized as having a relationship in S109 by reading and executing the second commit extraction program 160. The information processing program according to the embodiment can further cause the user interface 40 to display the result extracted as the commit for the first variation extracted in the S110.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and gist of the invention, and are included in the invention described in the claims and the equivalent scope thereof.

Hereinafter, the invention of the embodiment will be described below.

<1> A non-transitory computer-readable storage medium storing a program that causes a processing circuitry to execute operations comprising:
comparing a first commit and a second commit for a first variation branch branching from a development branch at a first timing, and
extracting the second commit as a commit for a first variation when there is a difference between the first commit and the second commit, wherein
the first commit and the second commit are programs described in a source code and are registered in a configuration management tool, and
the first commit and the second commit are registered in a development branch of the configuration management tool after the first timing.

<2> The non-transitory computer-readable storage medium storing the program according to <1>, that causes the processing circuitry to execute operations comprising:
extracting a commit registered in the development branch before the second commit as a commit for the first variation.

<3> The non-transitory computer-readable storage medium storing the program according to <1> or <2>, that causes the processing circuitry to execute operations comprising:
incorporating a commit for the first variation in the first variation branch.

<4> The non-transitory computer-readable storage medium storing the program according to any one of <1> to <3>, that causes the processing circuitry to execute operations comprising:
referring to a task management tool in which supplementary information of the commit is recorded when extracting the commit for the first variation.

<5> The non-transitory computer-readable storage medium storing the program according to any one of <1> to <4>, that causes the processing circuitry to execute operations comprising:
detecting switching of a compile switch in the development branch, and
registering a commit registered in the development branch by the timing of the switching in a check work branch branched from the development branch at the first timing.

<6> The non-transitory computer-readable storage medium storing the program according to any one of <1> to <5>, that causes the processing circuitry to execute operations comprising:
displaying a result extracted as the commit for the first variation on a user interface.

<7> A data processing apparatus comprising:
a processing circuitry is configured to
compare a first commit and a second commit for a first variation branch branched from a development branch at a first timing, and
extract the second commit as a commit for a first variation when there is a difference between the first commit and the second commit, wherein
a first commit and a second commit, which are programs described in a source code, are registered in a configuration management tool, and
the first commit and the second commit are registered in the development branch of the configuration management tool after the first timing.

<8> A data processing method executed by the processing circuitry, the method comprising:
comparing a first commit and a second commit for a first variation branch branching from a development branch at a first timing, and
extracting the second commit as a commit for a first variation when there is a difference between the first commit and the second commit, wherein
the first commit and the second commit are programs described in a source code and are registered in a configuration management tool, and
the first commit and the second commit are registered in a development branch of the configuration management tool after the first timing.

What is claimed is:

1. A non-transitory computer-readable storage medium storing a program that causes a processing circuitry to execute operations comprising:
comparing a first commit and a second commit for a first variation branch branching from a development branch at a first timing, and
extracting the second commit as a commit for a first variation when there is a difference between the first commit and the second commit, wherein
the first commit and the second commit are programs described in a source code and are registered in a configuration management tool, and
the first commit and the second commit are registered in a development branch of the configuration management tool after the first timing.

2. The non-transitory computer-readable storage medium storing the program according to claim 1, that causes the processing circuitry to execute operations comprising:
extracting a commit registered in the development branch before the second commit as a commit for the first variation.

3. The non-transitory computer-readable storage medium storing the program according to claim 1, that causes the processing circuitry to execute operations comprising:
incorporating a commit for the first variation in the first variation branch.

4. The non-transitory computer-readable storage medium storing the program according to claim 1, that causes the processing circuitry to execute operations comprising:
referring to a task management tool in which supplementary information of the commit is recorded when extracting the commit for the first variation.

5. The non-transitory computer-readable storage medium storing the program according to claim 1, that causes the processing circuitry to execute operations comprising:
detecting switching of a compile switch in the development branch, and
registering a commit registered in the development branch by the timing of the switching in a check work branch branched from the development branch at the first timing.

6. The non-transitory computer-readable storage medium storing the program according to claim 1, that causes the processing circuitry to execute operations comprising:
displaying a result extracted as the commit for the first variation on a user interface.

7. A data processing apparatus comprising:
a processing circuitry is configured to
compare a first commit and a second commit for a first variation branch branched from a development branch at a first timing, and
extract the second commit as a commit for a first variation when there is a difference between the first commit and the second commit, wherein
a first commit and a second commit, which are programs described in a source code, are registered in a configuration management tool, and
the first commit and the second commit are registered in the development branch of the configuration management tool after the first timing.

8. A data processing method executed by the processing circuitry, the method comprising:
comparing a first commit and a second commit for a first variation branch branching from a development branch at a first timing, and
extracting the second commit as a commit for a first variation when there is a difference between the first commit and the second commit, wherein
the first commit and the second commit are programs described in a source code and are registered in a configuration management tool, and
the first commit and the second commit are registered in a development branch of the configuration management tool after the first timing.
